(19) United States
(12) Patent Application Publication
(10) Pub. No.: US 2008/0115160 A1
(43) Pub. Date: May 15, 2008

(54) Method, system and apparatus for offering and receiving event reminders using a trusted intermediary

(75) Inventors: Steven J. Palo, Rochester, NY (US); Daniel S. Agnew, Fairport, NY (US)

Correspondence Address: SHLESINGER & FITZSIMMONS, 183 EAST MAIN STREET, SUITE 1323, ROCHESTER, NY, 14604, US

(73) Assignee: MyMinderz, Inc.

(21) Appl. No.: 11/586,459

(22) Filed: Oct. 25, 2006

(51) Int. Cl. H04N 7/16; H04N 5/445; G06F 3/00; G06F 13/00

(52) U.S. Cl. 725/25; 725/58; 725/60; 725/61

(57) ABSTRACT

A system and method for reminding people of upcoming events includes stored event information browsable by reminder receivers and potential reminder receivers. to become a receiver, people subscribe, entering contact information that is stored by the system. Event holders also subscribe to the system to be able to list events. Holders enter date, time, and venue information, and can optionally include a title and/or a description, and have full access to their event information, but have no access to the receiver contact information, protecting receivers from undesired contact.

### BACKGROUND AND SUMMARY

Today's average person has become busier and busier and has difficulty remembering events they need to attend. People have developed various ways to keep track of such events, including paper calendars, personal information managers, personal digital assistants, computer and internet based scheduling systems, and even cell phones. Many holders of events, such as bands, festivals, conventions, plays, performers themselves, schools, tours, sports teams, venues, and the like, list events that will be occurring in the future so that people interested in attending such events can locate the information regarding date, time, and location. Such listings are done through conventional hard copy media, such as posters, newspapers, magazines, and so-called “table tents,” as well as through electronic media, such as via the internet, the world wide web, and cell phone networks. However, many people acquiring or viewing this information often do not have an easy way to enter the information in a calendar or to provide reminders for themselves of the upcoming event.

Embodiments provide such an easy way to create reminders of upcoming events. Event holders create an account on the system of embodiments and enter information about upcoming events, such as date, time, location, and description. As is likely apparent, the system on which embodiments are implemented is a computer, preferably connected to the internet and running http and other server software. Potential attendees (receivers) can then browse upcoming events on the system or on holder web sties, and a receiver can click a link to create a reminder that will automatically be sent to the receiver at a predetermined period before the event. If the receiver is not already a member of and logged into the system of embodiments, the system will prompt the receiver to log in or to create a receiver account before creating the reminder. Preferably, the reminder is in the form of a text message, such as a SMS protocol message, sent to a cellular device, such as a cell phone.

The events are not limited to single concerts, plays, or other one-time events, but can be much more diverse. For example, employers can be holders, have their employees sign up as receivers, and send work schedules or other relevant information to employees as reminders. Other scenarios are contemplated by embodiments, as well, as will be described below.

By allowing reminder receivers to subscribe to the service, receiver contact information can be retained on the system and, trough use of cookies, AJAX, and the like, the receiver can simply click on a button to activate a reminder for a particular event with a default reminder format. Embodiments allow the receiver to edit the default reminder format to change the information transmitted and/or the predetermined period of time before the event at which the reminder is sent. To protect receivers from the dissemination of their contact information, embodiments exclude holders from the receiver information database. Thus, receivers can browse and activate reminders for as many events as they wish from as many different holders as may be, yet be secure in the knowledge that their contact information will not be shared with the holders, thus preventing undesired contact and/or solicitations. Additionally, embodiments facilitate receipt of reminders in a confidential fashion so that a receiver can maintain the privacy of his or her upcoming attendance to various events as between other individuals in his or her circle.

As a facilitating measure, embodiments provide for reminder request without the use of a computer by a receiver. In such embodiments, the computer that receives requests is equipped to receive the requests via an alternate path, such as via SMS or other text messaging or voice telephone calls, or is connected to another computer that can receive requests via the alternate path. Each event in the stored event information can have a unique identifier, such as a sequence of numbers, that can be included on event announcements, such as posters, television commercials, print ads in newspapers and magazines, and the like, which also includes a telephone number or other code, such as so-called “short code,” that connects to the system of embodiments. A receiver can then make the request via the alternate path using the code and the unique identifier. If using text messaging, the receiver sends a text message to the telephone number or other code to the system along with the identifier for the event. If the messaging device used to send the request is in the receiver information, the system schedules the reminder. If not, the system places the reminder on hold until the messaging device is used to subscribe to the system.

If using voice telephone communication, the receiver dials the telephone number and uses the identifier to request a reminder of the event. If the receiver calls from the SMS-equipped telephone with which the receiver signed up, the system can use CallerID to automatically recognize the receiver and add the reminder. If the receiver calls from another phone or is not yet signed up, the system can prompt the receiver for a subscribed telephone number or to subscribe. Additionally, the system can speak the number to which the reminder will be sent to confirm the destination, allowing the receiver to change the number to which the reminder will be sent. Rather than allowing subscription over the phone, embodiments can place the reminder of a new subscriber on hold, encourage the requesting receiver to visit the system web site to subscribe, and add the event automatically when the number associated with the reminder is included in a subscription.

### BRIEF DESCRIPTION OF THE DRAWINGS

FIG. 1 shows a schematic diagram of the system of embodiments.

FIG. 2 shows a schematic flow diagram of a method according to embodiments.

FIG. 3 shows a schematic flow diagram of a method according to embodiments.

FIG. 4 shows a schematic flow diagram of a method according to embodiments.

### DESCRIPTION

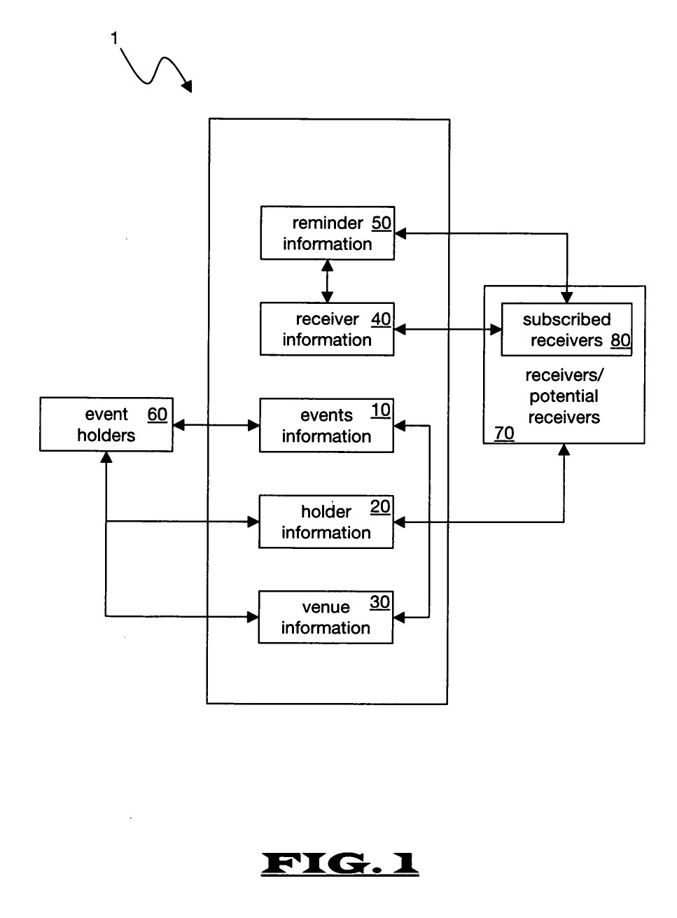

With reference to the accompanying drawings, embodiments comprise a reminder system 1, such as that seen schematically in FIG. 1, in which event information 10, event holder 20 information, venue information 30, receiver information 40, and reminder information 50 are stored. Such a reminder system 1 is preferably implemented in a computer, and such computer is preferably connected to the internet and to at least one cellular telephone network. Event holders 60 have access to the venue information 30, holder information 20, and event information 10, but do not have access to the receiver information 40 or to the reminder information 50. Receivers 70 also have access to the event, holder, and venue information 10, 20, 30 on a read-only basis, though subscribed receivers 80 additionally have access to their respective receiver and reminder information 40, 50.

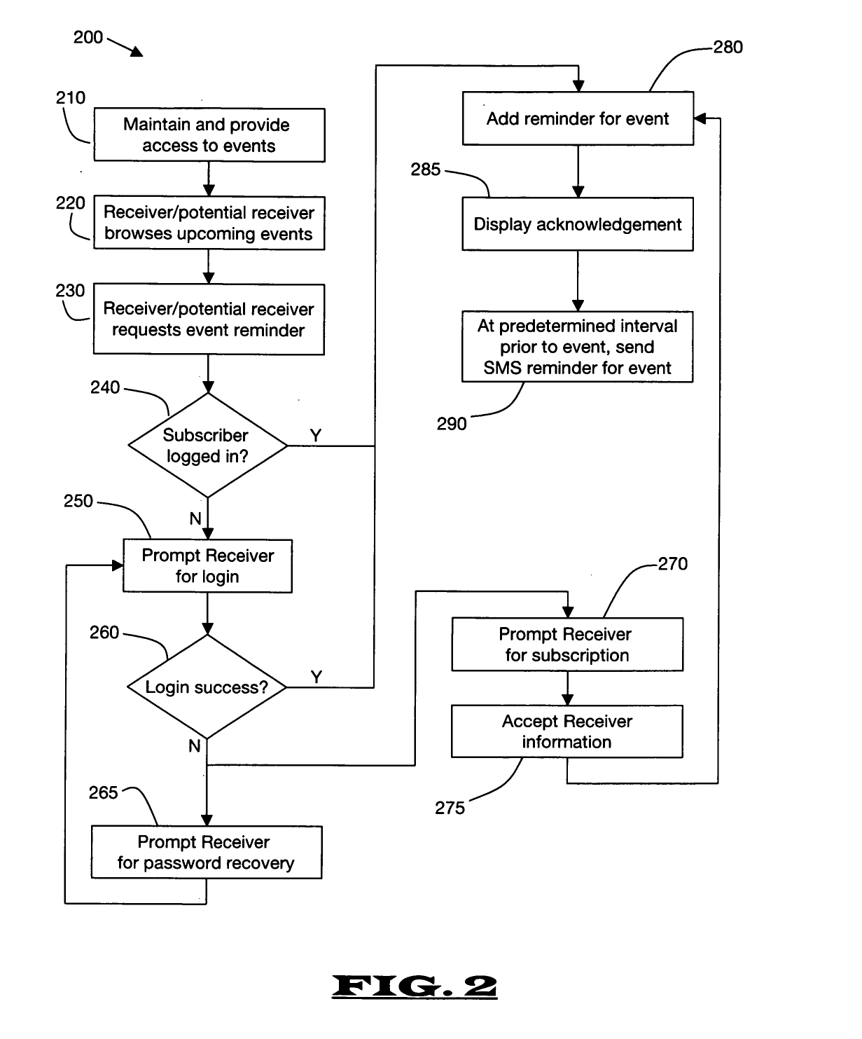

As seen in FIG. 2, a reminder method 200 according to embodiments includes maintaining and providing access to event information 210, allowing receivers and potential receivers to browse events 220, and receiving a request for a reminder for a particular event 230. The reminder system 1 checks to see if the receiver is logged in 240. If so, then the reminder system 1 proceeds to adding the requested reminder to the receiver's account 280. If the receiver is not logged in, the reminder system 1 prompts the receiver for login information 250 and checks to see if the login is successful 260. If the login is successful, then the reminder system 1 proceeds to adding the requested reminder to the receiver's account 280. If the login is unsuccessful, the reminder system 1 offers password recovery 265 for subscribers and offers subscription for receivers not yet subscribed 270. If the receiver opts for password recovery, the reminder system 1, after proceeding with password recovery steps, returns to prompting the receiver for login information 250. If the receiver opts for subscription, the reminder system 1 accepts the receiver's information 275, such as cell phone number, name, address, and the like, establishing an account for the receiver, and continues to adding the requested reminder to the receiver's account 280. Preferably, the system acknowledges the creation/scheduling of the reminder by displaying an acknowledgement message 285, such as a message on the page on refresh or AJAX, a popup window, an e-mail message, or other suitable message format. At a predetermined interval prior to the event, the reminder system 1 sends an SMS/text message reminder to the receiver 290 as requested. Embodiments also provide for editing of reminders by receivers to customize the content of the reminders, the time at which the reminders are sent, and more.

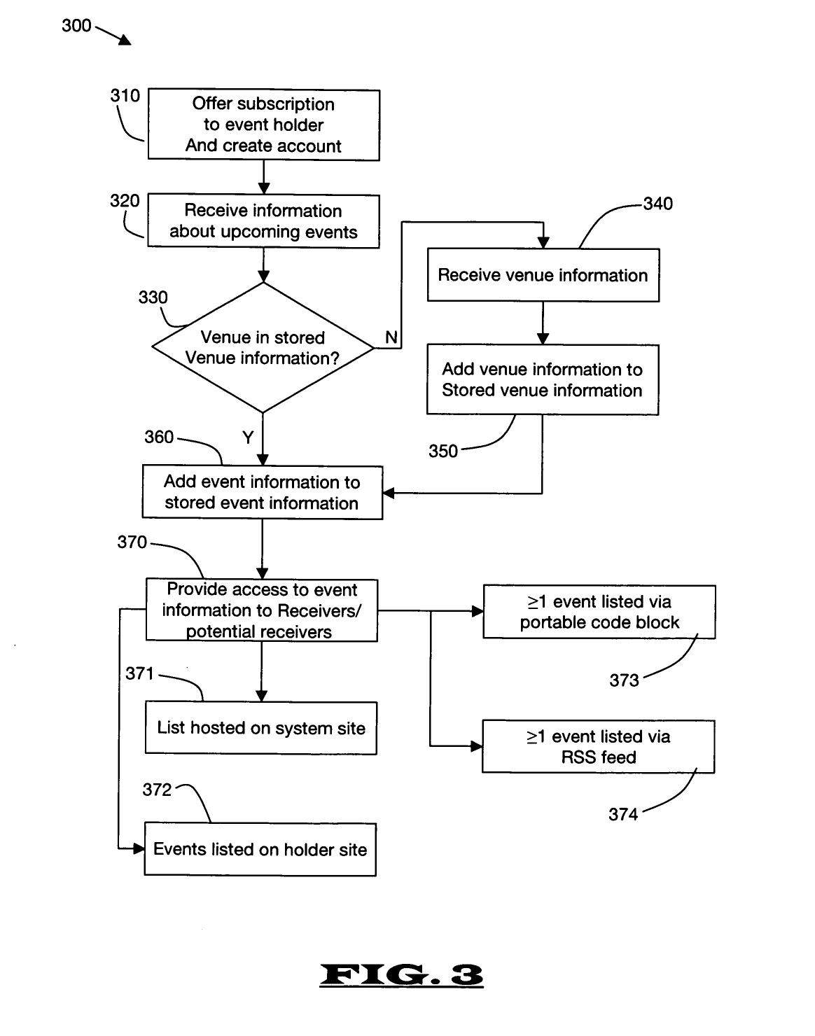

Another aspect of embodiments is the collection and maintenance of event information, as well as providing access to event information, as shown in 210 of the method schematically illustrated in FIG. 2. Embodiments, with reference to FIG. 3, allow event holders to subscribe to the reminder system 1 (310). Event holders can then enter event information 320, selecting venues from the venue information 330 or entering new venue information 340 to be retained in the system venue information for future use 350. For each event, holders preferably enter date, time, name/title, and a description of the event 360, though the description is optional. The reminder system 1 then provides access to the event information 370, such as by listing such event information on a web site 371, 372, and/or by providing a portable block of code 373, commonly referred to as a “web sticker” or “button,” that can be inserted into the code of a web site such that the event and its reminder can be accessed from the site into which the block is inserted. This can be done for each event and can be included on another web site, such as that of a respective holder, or in an HTML e-mail message. The portable block of code, preferably includes an image and a link to the event information stored in embodiments so that one viewing the site in which the portable code block is inserted can click the image and/or link to initiate a reminder for its respective event. Additionally, the reminder system 1 preferably places a cookie in each logged in receiver's web browser that allows such a receiver to simply click the image and/or link presented by the portable code block to request a reminder without having to log into the system again. Depending on the settings of the holder's web site, the receiver's account on the reminder system, and/or the portable code block, the request is acknowledged by a simple acknowledgement message in the web site, by an acknowledgement message in a pop-up window, by being taken to a reminder page at which the receiver can customize the reminder, by an acknowledgement e-mail message, or by another suitable method of acknowledging the request.

An additional feature of embodiments is the ability to provide a RSS (standing for “Rich Site Summary” or “Really Simple Syndication”) feed 374, As is known in the art, RSS feeds are web- or internet-accessible XML documents that a “feed reader” accesses periodically to check for changes. Such feeds can be used for accessing news headlines, receiving updates to weblogs, retrieving podcasts, and more. In this case, the feed would notify subscribers of changes to respective events. Alternatively, the feed can be specific to an event holder or venue, notifying subscribers of changes to a specific schedule of events,

Embodiments can be applied to send employee work schedules as reminders. An employer is the event holder is such embodiments, the employee being the reminder receiver. The employer sets up work schedules as events, requests that employees sign up for SMS reminders of their schedules, and can then send the work schedules to respective employees. The reminders can be sent on a daily basis, weekly basis, or other basis as desired by the employees and/or the employer.

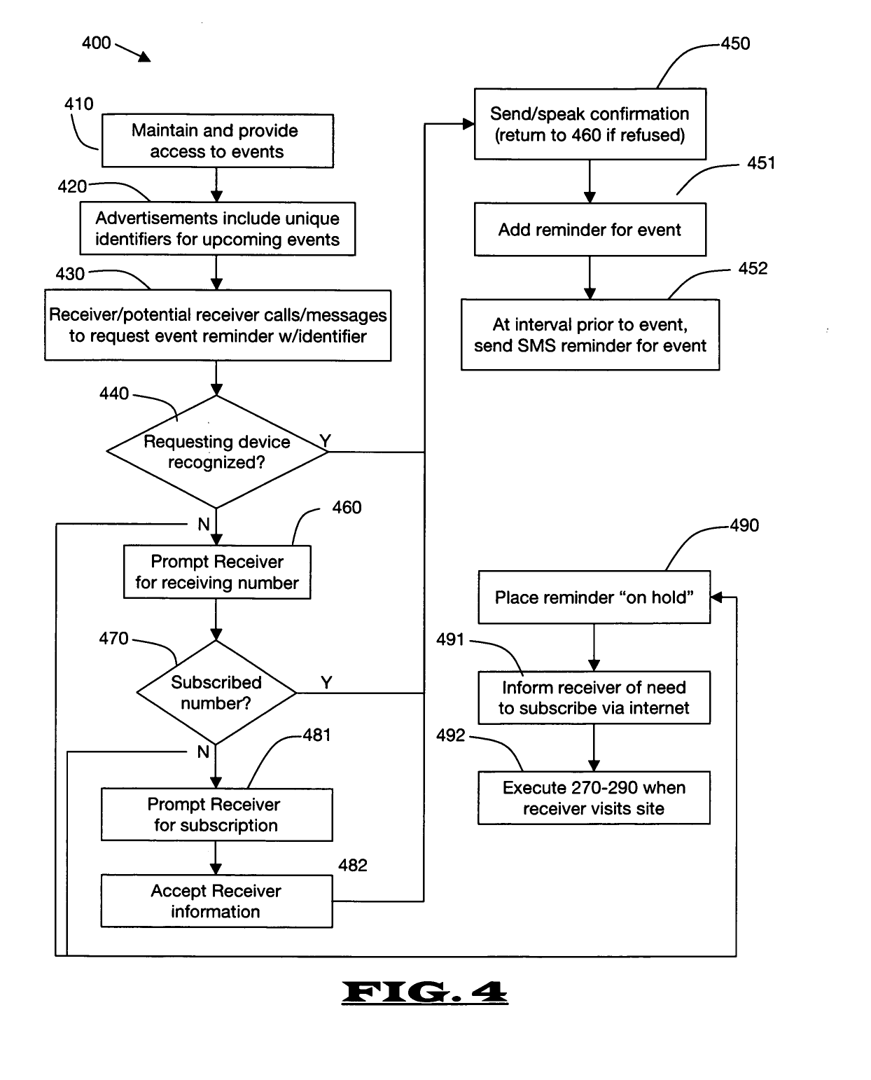

As a facilitating measure, embodiments can provide for reminder request without the use of a computer by a receiver. In such embodiments, as seen, for example, in FIG. 4, the computer that receives requests is equipped to receive requests via an alternate path, such as via SMS or other text messaging or telephone calls, or is connected to another computer that can receive requests via the alternate path. Thus, the system can execute a method of providing alternate access to event reminders 400 by maintaining and providing access to events 410. Each event in the stored event information can have a unique identifier, such as a sequence of numbers, that can be included on event announcements, such as posters, television commercials, print ads in newspapers and magazines, and the like, which also includes a telephone number or other code, such as so-called “short code,” that connects to the system of embodiments 420. A receiver can then use the alternate path with the code and the unique identifier to request a reminder of the event 430. If the requesting device is recognized 440, the system adds the reminder 450. In an alternate embodiment, the system can send or speak a confirmation 451 before adding the reminder. At an interval prior to even, the system send a reminder via SMS to the desired device 452. If the requesting device is not recognized, the system can place the reminder on hold 490 until the requesting receiver subscribes to the system.

If using text messaging, the receiver sends a text message to the telephone number or other code to the system along with the identifier for the event. If the messaging device used to send the request is in the receiver information, the system schedules the reminder. If not, the system places the reminder on hold until the messaging device becomes part of the receiver information via a subscription to the system.

If using voice telephone communication, the receiver dials the telephone number and uses the identifier to request a reminder of the event. If the receiver calls from the SMS-equipped telephone with which the receiver signed up, the system can use CallerID to automatically recognize the receiver 440, “speak” the receiving phone number to confirm the reminder 450, and add the reminder 451. At a interval prior to the event, the reminder is sent 452.

In an alternative embodiment, if the receiver makes the request from an unrecognized device, the system can prompt the receiver for a number to which the reminder should be sent 460. If the entered number is a subscribed number 470, then the system proceeds with 450-452. If not, then the system can prompt the requesting receiver for a subscription 481, accept the receiver information 482, and proceed with 450-452. Alternatively, if on-the-fly subscription is not offered, the system can place the reminder “on hold” 490 and inform the receiver that he/she needs to subscribe via the internet 491. The system can then add the event automatically when the number associated with the reminder is included in a subscription, such as with steps 270-290 in FIG. 2.

It will be appreciated that various of the above-disclosed and other features and functions, or alternatives thereof, may be desirably combined into many other different systems or applications. It will also be noted that various presently unforeseen or unanticipated alternatives, modifications, variations or improvements therein may be subsequently made by those skilled in the art which are also intended to be encompassed by the following claims.

What is claimed is:

1. A method of reminding comprising:
offering subscriptions to holders of events;
accepting event information pertaining to events the holders will hold;
storing the event information;
providing a reminder actuator with which a user can request a reminder for a respective event;
using receiver information including contact information for receiving SMS reminders to schedule a reminder for the respective event to be sent to the user requesting a reminder; and
sending a reminder via SMS to the member as scheduled.

2. The method of claim 1 further comprising checking to see if the user is a receiver whose contact information has been received.

3. The method of claim 1 further comprising accepting receiver information including contact information for receiving SMS reminders and storing the receiver information.

4. The method of claim 3 further comprising placing a cookie on the user's computer, the cookie indicating that the user is a receiver whose information has been received.

5. The method of claim 1 further comprising using a cookie on the user's computer to retrieve receiver information.

6. The method of claim 1 wherein providing a reminder actuator comprises providing a portable code block that refers to at least a link to the respective event.

7. The method of claim 7 wherein the portable code block further refers to a graphic image.

8. The method of claim 7 wherein providing a reminder actuator comprises including the portable code block in at least one of a HTML document and a XML document.

9. The method of claim 1 wherein providing a reminder actuator comprises providing a unique identifier and providing access to the event information comprises providing a code with which a receiver can request a reminder for the respective event by entering a the unique identifier.

10. The method of claim 9 wherein providing a reminder actuator further comprises checking a device from which the receiver requests a reminder and using receiver information comprises scheduling a reminder if the device is recognized.

11. The method of claim 10 wherein using subscriber information further comprises placing the reminder on hold if the device is not recognized.

12. The method of claim 11 further comprising providing subscription via telephone by prompting the receiver for subscription and accepting receiver information.

13. A method of reminding comprising:
storing event information entered by subscribed holders of events;
storing venue information with which event information can be associated;
providing access to the event information;
accepting a reminder request from a user for a particular event;
checking the user's status as a receiver;
subscribing the user as a receiver if the user is not yet a receiver, subscribing including accepting receiver information, the receiver information including at least contact information with which an SMS message can be received, and storing the receiver information;
identifying the user if the user is a receiver and retrieving the respective receiver information; and
scheduling a SMS message reminding the receiver of the particular event.

14. The method of claim 13 wherein scheduling a SMS reminder includes applying a default interval prior to the particular event.

15. The method of claim 13 wherein scheduling a SMS reminder includes allowing the receiver to indicate when the reminder should be sent.

16. The method of claim 13 wherein checking the user's status comprises checking for a cookie on a computer used by the user to access the event information and request the reminder.

17. The method of claim 13 wherein checking the user's status comprises requesting login information from the user in response to the request.

18. The method of claim 13 wherein providing access to the event information comprises maintaining an RSS feed.

19. The method of claim 13 wherein providing access to the event information comprises providing a link to each event.

20. The method of claim 19 wherein providing a link to each event comprises including the link in a portable code block insertable into a body of HTML.

21. A method of reminding comprising:
storing event information entered by subscribed holders of events;
storing venue information with which event information can be associated;
providing access to the event information to users of the internet by at least one of:
maintaining a RSS feed;
providing a link to each event; and
including a link to a respective event in a portable code block insertable into a body of HTML;
providing access to the event information via a telephone number;
accepting a reminder request from a user for a particular event;
checking the user's status as a receiver by:
if the user is requesting via the internet:
checking for a cookie on a computer used by the user to access the event information and request the reminder; and
requesting login information from the user in response to the request if no cookie is found;
if the user is requesting via alternate path:
checking the device from which the receiver makes the request; and
comparing a device identifier with the receiver information;
subscribing the user as a receiver if the user is not yet a receiver, subscribing including accepting receiver information, the receiver information including at least contact information with which an SMS message can be received, and storing the receiver information;
retrieving the respective receiver information;
scheduling a SMS message reminding the receiver of the particular event with a default interval prior to the particular event;
allowing the receiver to indicate when the SMS message should be sent, overriding the default interval if necessary.
